(19) United States
(12) Patent Application Publication
(10) Pub. No.: US 2004/0146084 A1
(43) Pub. Date: Jul. 29, 2004

(54) Component exposed to thermal loads

(76) Inventors: Andreas Hachtel, Leinfelden-Echterdingen (DE); Thomas Schulte, Stuttgart (DE); Thomas Wahl, Pforzheim (DE); Andy Tiefenbach, Ditzingen (DE); Johann Riegel, Bietigheim-Bissingen (DE); Bernd Schumann, Rutesheim (DE); Petra Kuschel, Leonberg-Hoefingen (DE); Thorsten Ochs, Schwieberdingen (DE); Annika Kristoffersson, Goteborg (SE); Stefan Nufer, Stuttgart (DE)

Correspondence Address: RONALD E. GREIGG, GREIGG & GREIGG P.L.L.C., Suite One, 1423 Powhatan Street, Alexandria, VA, 22314, US

(21) Appl. No.: 10/715,531

(22) Filed: Nov. 19, 2003

(30) Foreign Application Priority Data
Nov. 20, 2002 (DE) 1 02 53 978.2

(51) Int. Cl. G01K 3/00

(52) U.S. Cl. 374/106; 116/207; 116/217; 340/584

(57) ABSTRACT

A lambda sensor for motor vehicles which permanently displays an at least temporary thermal overload by means of an indicator which, for fast reliable and unambiguous diagnosis without major additional measurement effort or expense, includes an indication material having at least one limit temperature adapted to the maximum allowable operating temperature of the component, and when this limit temperature is exceeded in at least one material component, a microstructural change ensues.

### BACKGROUND OF THE INVENTION

1. Field of the Invention

The invention is directed to an improved component exposed to thermal loads, in particular a lambda sensor for motor vehicles having an indicator which permanently indicates an at least temporary thermal overload.

2. Description of the Prior Art

For lambda sensors of the type with which this invention is concerned, typically maximum allowable usage temperatures are prescribed, which if malfunctions or damage to the component are to be avoided must not be exceeded. Since the causes of failures in these components cannot always be diagnosed perfectly, it is known to equip such components with thermal indicators, which permanently indicate a thermal overload—even if the overload is only temporary—of the component to above its maximum allowable operating temperature.

In one known component of this type, a metal material that assumes a certain color, such as an annealing color, depending on the temperature is used as the indicator, so that within approximate temperature stages, for instance of 50° C., statements can be made about thermal load ranges to which the component was exposed. The metal material is for instance applied by coating accessible outside faces of the component.

### OBJECT AND SUMMARY OF THE INVENTION

The component of the invention, in particular a lambda sensor for motor vehicles, has the advantage that because of the microstructural change of the indication material when the limit temperature is exceeded, a rapid diagnosis can be made as to whether the cause of damage to the component can be ascribed to an impermissible operating temperature or not. The microstructural change that ensues if the limit temperature is exceeded is permanent and can be ascertained visually or analytically in a time-saving way with little measurement effort or expense. Unlike an indication made by way of a color change, the indication of the excessive temperature cannot be tampered with; in view of increasingly stringent product liability rules as well, this makes it easier to be certain of the evidence as to whether damage is caused by a product itself, or by impermissible operation.

In one advantageous feature of the invention, the indication material is composed such that microstructural changes occur in different material components when differently defined limit temperatures are exceeded. An embodiment of the thermal indicator of this kind is employed above all for testing purposes, in order to define different temperature ranges that can cause different degrees of damage to the component.

In a preferred feature of the invention, the indication material is a solid which undergoes a microstructural change by melting when the limit temperature is exceeded. A microstructural change of this kind, caused by a change of phase, is irreversible and can already be detected visually on the component. In alternative features of the invention, the microstructural change is caused by oxidation of the indication material when the limit temperature is exceeded, or by chemical reactions between the material components of the indication material when the limit temperature is exceeded.

In a preferred feature of the invention, a powder compaction of aluminum or aluminum alloys is used as the indication material; by accurate matching of components, one or more desired limit temperatures can be established.

In an advantageous feature of the invention, ceramic foams, in which a microstructural change can be established in a temperature range between 700 and 900° C., are also used as the indication material. Such a ceramic foam for instance includes an alloy of aluminum and magnesium with a proportion of magnesium oxide. If the limit temperature is exceeded, the reaction-sintered magnesium spinel (MgAl₂O₄) occurs.

In a further feature of the invention, thermoplastics such as polypropylene or PTFE are also used as the indication material. PTFE is especially suitable for components that are operated in a low temperature range, since limit temperatures can be established in a range between 300 and 350° C.

In an advantageous feature of the invention, if the component is embodied as a lambda sensor with a hexagonal nut for installation in the motor vehicle, a void is provided in the hexagonal nut, in the form of a blind bore into which the indication material is introduced under pressure, i.e., forced in.

### BRIEF DESCRIPTION OF THE DRAWINGS

The invention will be better understood and further objects and advantages thereof will become more apparent from the ensuing detailed description of a preferred embodiment taken in conjunction with the drawings, in which:

FIG. 1 shows a detail in side view of a lambda sensor, partly in section;

FIG. 2 is a detail taken along the line II-II in FIG. 1;

FIG. 3 is a micrograph of an indication material introduced into a blind bore in the lambda sensor;

FIG. 4 is a plan view on the indication material, after a thermal overload that exceeds a first limit temperature; and

FIG. 5 is a detail of a micrograph of the indication material after a thermal overload above a second limit temperature.

### DESCRIPTION OF THE PREFERRED EMBODIMENTS

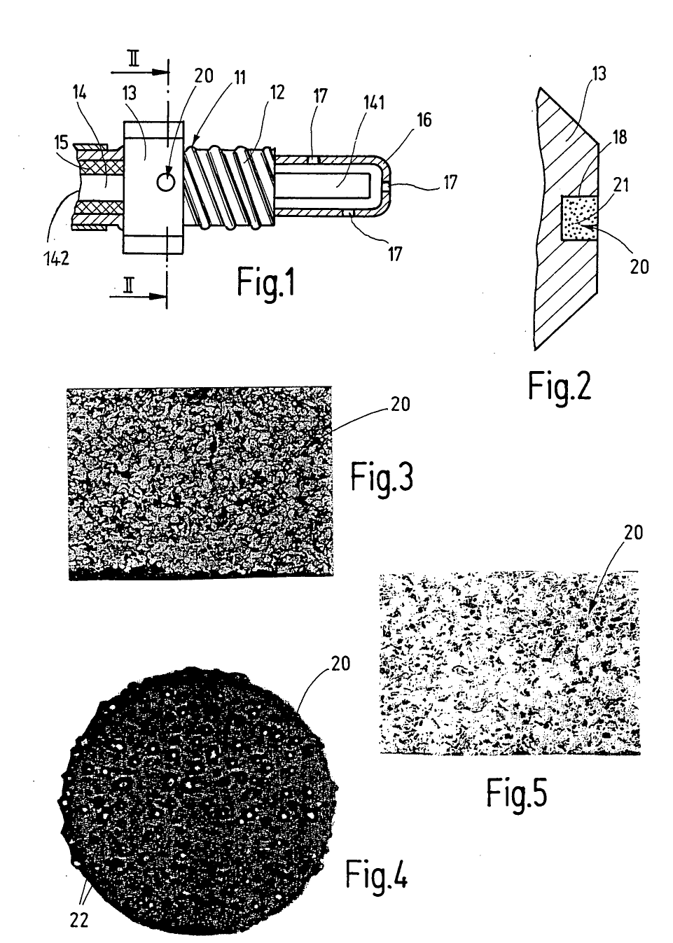

The lambda sensor, shown as a detail and partly in section in FIG. 1, as an exemplary embodiment for a component in general that is exposed to a thermal overload serves to define the oxygen content in the exhaust gas of the internal combustion engine of a motor vehicle. It has a metal housing 11, which has a thread 12 as a fastening means for incorporation into an exhaust pipe of the engine and on which a hexagonal nut 13 is embodied for installing the lambda sensor. A longitudinal bore is provided in the housing 11, and a platelike sensor element 14 passes through this bore. On the side toward the gas to be measured, the sensor element 14 has an end portion 141 that is exposed to the exhaust gas and on the connection side an end portion 142 where the sensor element 14 is made to contact electrical connection lines. The sensor element 14 is received in gastight fashion in the longitudinal bore by means of two ceramic molded parts and a seal between them. Of the ceramic molded parts, only the ceramic molded part 15 can be seen in FIG. 4; this is the ceramic molded part oriented toward the end portion 142, on the connection side, of the sensor element 14. The end portion 141, on the side toward the gas to be measured, of the sensor element 14 protrudes out from the housing 11 and there is surrounded by a guard tube 16, which is affixed to the housing 11. The guard tube 16 has inlet and outlet openings 17 for the exhaust gas to be measured.

Integrated with the lambda sensor is an indicator 20, which permanently indicates a thermal overload—even if only temporary—on the lambda sensor from excessively hot exhaust gas. To that end, a blind bore 18 which is filled with an indication material 21 is made in the hexagonal nut 13 (FIG. 2). This indication material 21 has a limit temperature which changes its microscopic structure when exceeded, for instance as the result of a melting process. The limit temperature of the indication material is adapted to the maximum allowable operating temperature of the lambda sensor, or in other words of the sensor element 14, in such a way that it either corresponds to that operating temperature or is only slightly above it. If the lambda sensor is then thermally overloaded during its operation, the result of which ranges from an impairment in the function of the sensor element 14 to the complete failure of the lambda sensor, then after the limit temperature is exceeded, the microstructure of the indication material 21 also changes. This microstructural change can be ascertained quickly and simply, for instance from the visual appearance. Thus a fast diagnosis as to whether a malfunction or failure of the lambda sensor can be ascribed to a thermal overload, or not, can be made.

In the exemplary embodiment shown, the indication material is a ceramic foam, which is forced into the blind bore 18. The ceramic foam is made up of approximately 68 vol-% (volume percent) of an aluminum-magnesium alloy (AlMg₅) and about 32 vol-% of magnesium oxide (MgO). Such a ceramic foam, in a temperature range that is below the limit temperature of approximately 650° C., has a microstructure that is schematically sketched in FIG. 3. If this limit temperature is exceeded, a visually apparent sweating out of aluminum beads 22 occurs, and these beads can readily be seen on the surface (FIG. 4). This sweating out of aluminum beads 22 occurs up to a second limit temperature of approximately 750° C. If this second limit temperature is exceeded, the outflowing aluminum enters into a chemical reaction with the magnesium oxide, leading to a so-called reaction-sintered magnesium spinel (MgAl₂O₄), whose structure is shown schematically in FIG. 5. Since in both cases (FIG. 4 and FIG. 5) the microstructural change of the ceramic foam is permanent, it can be proven quickly, reliably and unambiguously and at little effort or expense for measurement whether the lambda sensor was exposed—even if only temporarily —to a thermal overload of approximately 650° C. to approximately 750° C. (FIG. 4), or to a thermal load of over approximately 750° C.

As the indication material, aluminum can also be used, for instance in powder form, and forced into the blind bore 18. The pressing is sufficient to fix the indicator 20 firmly in the blind bore 18. If there is a loose powder filling, however, the blind bore 18 can additionally be closed with an easily removed layer. With this kind of powder compaction of aluminum, a limit temperature of approximately 650° C. can once again be established. A precise adaptation in terms of the limit temperature at which a thermal overload is to be detected is made possible by using aluminum alloys, such as alloys of aluminum and silicon or aluminum and magnesium.

For indicating or detecting thermal overload in a temperature range <500° C., plastics which form thermoplastics when the limit temperature is exceeded are used as the indication material. One such plastic is polypropylene, or PTFE, with a detection temperature range from 300° C. to 350° C.

The foregoing relates to preferred exemplary embodiments of the invention, it being understood that other variants and embodiments thereof are possible within the spirit and scope of the invention, the latter being defined by the appended claims.

We claim:

1. In a lambda sensor for motor vehicles, having an integrated indicator (20), which permanently indicates an at least temporary thermal overload, the improvement wherein the indicator (20) comprises a body of indication material (21), with at least one limit temperature adapted to the maximum allowable operating temperature of the component, which limit temperature when it is exceeded causes a microstructural change in at least one component of the indication material.

2. The lambda sensor in accordance with claim 1, wherein the composition of the indication material (21) is such that microstructural changes in different material components occur when a plurality of limit temperatures are exceeded.

3. The lambda sensor in accordance with claim 1, wherein the indication material (21) is a solid which when the limit temperature is exceeded undergoes a microstructural change as a result of melting.

4. The lambda sensor in accordance with claim 2, wherein the indication material (21) is a solid which when the limit temperature is exceeded undergoes a microstructural change as a result of melting.

5. The lambda sensor in accordance with claim 1, wherein the indication material (21) is a solid which when the limit temperature is exceeded undergoes a microstructural change as a result of oxidation.

6. The lambda sensor in accordance with claim 2, wherein the indication material (21) is a solid which when the limit temperature is exceeded undergoes a microstructural change as a result of oxidation.

7. The lambda sensor in accordance with claim 1, wherein the indication material (21) is a solid having material components which when the limit temperature is exceeded undergo a microstructural change as a result of chemical reaction.

8. The lambda sensor in accordance with claim 2, wherein the indication material (21) is a solid having material components which when the limit temperature is exceeded undergo a microstructural change as a result of chemical reaction.

9. The lambda sensor in accordance with claim 1, wherein the component comprises a void (20), and wherein the void (20) is filled with the indication material (21).

10. The lambda sensor in accordance with claim 2, wherein the component comprises a void (20), and wherein the void (20) is filled with the indication material (21).

11. The lambda sensor in accordance with claim 9, further comprising means closing the material-filled void (20) in the component.

12. The lambda sensor in accordance with claim 2, further comprising means closing the material-filled void (20) in the component.

13. The lambda sensor in accordance with claim 9, wherein the filling of the void (20) in the component is done by introduction under pressure.

14. The lambda sensor in accordance with claim 11, wherein the filling of the void (20) in the component is done by introduction under pressure.

15. The lambda sensor in accordance with claim 1, wherein the indication material (21) comprises a powder compaction of aluminum or aluminum alloy.

16. The lambda sensor in accordance with claim 2, wherein the indication material (21) comprises a powder compaction of aluminum or aluminum alloy.

17. The lambda sensor in accordance with claim 13, wherein the indication material (21) comprises a powder compaction of aluminum or aluminum alloy.

18. The lambda sensor in accordance with claim 1, wherein the indication material (21) comprises a ceramic foam.

19. The lambda sensor in accordance with claim 1, wherein the indication material (21) comprises a thermoplastic.

20. The lambda sensor in accordance with claim 9, wherein the lambda sensor comprises a hexagonal nut (13) for assembly, and wherein the void in the component is in the form of a blind bore (18) made in the hexagonal nut (13).
